(19) United States
(12) Patent Application Publication
(10) Pub. No.: US 2011/0255159 A1
(43) Pub. Date: Oct. 20, 2011

(54) AUTOSTEREOSCOPIC DISPLAY DEVICE

(75) Inventors: Marcellinus Petrus Carolus Michael Krijn, Eindhoven (NL); Siebe Tjerk De Zwart, Eindhoven (NL); Robert-Paul Mario Berretty, Eindhoven (NL); Jan Van Der Horst, Eindhoven (NL); Bart Gerard Bernard Barenbrug, Eindhoven (NL)

(73) Assignee: KONINKLIJKE PHILIPS ELECTRONICS N.V., EINDHOVEN (NL)

(21) Appl. No.: 13/141,229

(22) PCT Filed: Dec. 16, 2009
(86) PCT No.: PCT/IB2009/055789

§ 371 Date: Jun. 21, 2011

(30) Foreign Application Priority Data
Dec. 22, 2008 (EP) 08172491.6

(51) Int. Cl. G02B 27/22

(52) U.S. Cl. 359/463

(57) ABSTRACT

There is disclosed a multi-view autostereoscopic display device comprising an image forming means arranged over and in registration with a view forming module. The image forming means has a planar array of light emissive display pixels arranged in rows and columns for producing a display, the display pixels being spatially defined by an opaque matrix. The image forming means may, for example, be a LCD display panel. The view forming module is configurable to function as a plurality of view forming elements arranged in the width direction of the display device, each view forming element focusing the light output from an adjacent group of the display pixels into a plurality of views for projection towards a user in respective different directions. The view forming module may, for example, be an array of lenticular lenses. The geometry of the view forming elements defines a substantially periodic inter-element variation in the width direction of the display device, for reducing brightness non-uniformities in the views. The inter-element variation may, for example, be provided by varying at least one of the widths, the focusing powers and the relative positions of the geometric axes of the lenticular lenses in the width direction of the display device.

### FIELD OF THE INVENTION

This invention relates to an autostereoscopic display device comprising an image forming means, such as a display panel having an array of display pixels, and a view forming module. The view forming module is, or is configurable to function as, an array of view forming elements arranged over the image forming means and through which the display pixels are viewed. The invention also relates to an autostereoscopic imaging method.

### BACKGROUND OF THE INVENTION

A known autostereoscopic display device is described in GB 2196166 A. This known device comprises a two dimensional emissive liquid crystal display panel having a row and column array of display pixels acting as an image forming means to produce a display. An array of elongate lenticular lenses extending parallel to one another overlies the display pixel array and acts as a view forming means. Outputs from the display pixels are projected through these lenticular lenses, which lenses function to modify the directions of the outputs.

The lenticular lenses are provided as a sheet of elements, each of which comprises an elongate semi-cylindrical lens element. The lenticular lenses extend in the column direction of the display panel, with each lenticular lens overlying a respective group of two or more adjacent columns of display pixels. A focal point of each lens coincides with a plane defined by the array of display pixels.

In an arrangement in which, for example, each lenticular lens is associated with two columns of display pixels, the display pixels in each column provide a vertical slice of a respective two dimensional sub-image. The lenticular sheet projects these two slices and corresponding slices from the display pixel columns associated with the other lenticular lenses, to the left and right eyes of a user positioned in front of the sheet, so that the user observes a single stereoscopic image.

In other arrangements, each lenticular lens is associated with a group of three or more adjacent display pixels in the row direction. Corresponding columns of display pixels in each group are arranged appropriately to provide a vertical slice from a respective two dimensional sub-image. As a user's head is moved from left to right a series of successive, different, stereoscopic views are observed creating, for example, a look-around impression.

The above described autostereoscopic display device produces a display having good levels of brightness. However, a problem associated with the device is that the views projected by the lenticular sheet are separated by dark zones caused by “imaging” of the non-emitting black matrix which typically defines the display pixel array. These dark zones are readily observed by a user as brightness non-uniformities in the form of dark vertical bands spaced across the display. The bands are perceived as a moiré like interference effect. The bands move across the display as the user moves from left to right and the pitch of the bands changes as the user moves towards or away from the display.

### SUMMARY OF THE INVENTION

It is inter alia an object of the invention to reduce the effect of banding. The object is achieved with the present invention. The invention is defined by the independent claims. The dependent claims provide advantageous embodiments.

According to a first aspect of the present invention, there is provided a view forming module for arrangement over and in registration with an image forming means of an autostereoscopic display device, the image forming means having a planar array of display pixels arranged in rows and columns for producing a display,

the view forming module being configurable to function as a plurality of view forming elements arranged in the width direction of the display device, each view forming element focusing the output from an adjacent group of the display pixels into a plurality of views for projection towards a user in respective different directions,

wherein the geometry of the view forming elements defines a substantially periodic inter-element variation in the width direction of the display device, for reducing brightness non-uniformities in the views.

Essentially, it has been found that the brightness non-uniformities caused by imaging of an opaque matrix in an autostereoscopic display device can be very effectively reduced by deliberately configuring the geometry of the view forming elements to have a periodic inter-element variation in the width direction of the display device.

For the purpose of the invention, the term opaque matrix is to be interpreted broadly. Thus it is intended to include any parts of the image forming means that provides less light for the image to be produced than the active area formed by the display pixels. One may say that the pixels are spatially defined by the opaque matrix. In extreme cases the opaque matrix may be a black matrix, as known in for example in image forming means in the form of cathode ray tubes (CRT) or liquid crystal displays LCD. In that case the invention may be particularly advantageous as the contrast between pixel and black matrix is high. Such matrix may be present in separate layer form , e.g. a mask, or as part of the image forming means. Thus also in image forming means where an area of the image forming means has a light providing pixel and a non-light providing boundary, the matrix composed of the boundary parts are to be regarded as an opaque matrix.

In embodiments of the invention, the views projected by individual view forming element of the view forming module will generally include significant brightness non-uniformities caused by imaging of the opaque matrix. However, the inter-element variation according to the invention causes the view forming elements to project views having respective different distributions of brightness non-uniformities. The different distributions may be selected so that the brightness non-uniformities produced by the view forming elements effectively cancel each other out. In this way, an improved three dimensional effect may be perceived by the user.

The periodic inter-element variation is provided by arranging successive view forming elements of the view forming module to alternate between at least two different geometries. For example, “odd” view forming elements may be configured to have a first geometry and “even” view forming elements may be configured to have a second geometry different to the first geometry. Elements having the first and second geometries may each project views having brightness non-uniformities, but these brightness non-uniformities may, according to the invention, be projected in respective different directions to thereby minimise their detrimental effects.

The view forming module according to the invention may also employ other techniques for minimizing brightness non-uniformities, such as the known techniques of slanting the view forming elements, fractional view arrangements and/or defocusing of the view forming elements described above.

The view forming module according to the invention may be suitable for use with an image forming means having the display pixels arranged in an orthogonal row and column array, or in any other suitable arrangement. For example, the display pixels of the image forming means may have a hexagonal arrangement addressed by rows and columns of electrodes.

The view forming elements may, for example, be lenses or elongate slits formed in a barrier layer. In general, lenses are preferred as they are able to provide a more efficient display device, since most of the light output from the image forming means is projected as views, while barrier layers block a substantial part of the light provided. Nevertheless, the invention will provide the described advantages for these barrier types of view forming elements, which generally are a an array of pairs of a barrier and a translucent slit The geometry of elongate slits, for example, can be varied according to the invention by varying the positions and widths of the slits in the barrier layer. The detailed working principle of providing the different views for the two eyes of a viewer for parallax barrier display systems are well described in for example WO2006/068426 or U.S. Pat. No. 7,154,653, and will not be repeated here for conciseness. The geometry of lenticular lenses, for example, can be varied according to the invention by introducing asymmetry to the lateral cross-sections of the lenses. In embodiments in which the view forming elements are lenticular lenses, the inter-element variation may be provided by varying at least one of the widths of the lenses, the focusing powers of the lenses and the positions, in the width direction of the display device, of the geometric axes of the lenticular lenses relative to their longitudinal centrelines.

In embodiments in which the periodic inter-element variation includes a variation in the focusing powers of the lenticular lenses, this may be provided by varying at least one of the radii of curvature of the lenses and the refractive indices of the media which define the lenses. The average focal length of the lenticular lenses may substantially correspond to the distance between the planes of the image forming means and the view forming module (as is the case for all of the lenticular lenses in known view forming modules). The focal lengths of the individual lenses may differ from this average focal length by from 1% to 20%, preferably from 2% to 15% and more preferably from 5% to 10%.

In embodiments in which the periodic inter-element variation includes a variation in the positions, in the width direction of the display device, of the geometric axes of the lenticular lenses relative to their longitudinal centrelines, the average displacement of the geometric axes of the lenticular lenses relative to their centrelines may be substantially zero.

In one group of these embodiments of the invention, the period of the inter-element variation corresponds to two lenticular lenses. The positions, in the width direction of the display device, of the geometric axes of successive ones of the lenses may then be displaced in alternate directions relative to the longitudinal centrelines of the lenses, and the widths of the lenses are conFig.d to be identical.

In another group of these embodiments, the period of the inter-element variation corresponds to three lenticular lenses. The position, in the width direction of the display device, of the geometric axis of a first lens in each triplet of the lenses is displaced a first direction relative to the longitudinal centreline of the lens. The position, in the width direction of the display device, of the geometric axis of a second lens in each triplet of the lenses is undisplaced relative to the longitudinal centreline of the lens. The position, in the width direction of the display device, of the geometric axis of a third lens in each triplet of the lenses is displaced a second direction, opposite to the first direction, relative to the longitudinal centreline of the lens.

In yet another group of these embodiments, the period of the inter-element variation corresponds to four lenticular lenses. The positions, in the width direction of the display device, of the geometric axes of successive pairs of the lenses may then be displaced in alternate directions relative to the longitudinal centrelines of the lenses. The positions, in the width direction of the display device, of the geometric axes of the lenses in each of the pairs may be displaced by different amounts relative to the longitudinal centrelines of the lenses. In these embodiments, the widths of the lenticular lenses may be configured to vary so that points on the surfaces of the lenticular lenses having positions, in the width direction of the display device, corresponding to the geometric axes of the lenses, together define a plane. It has been found that these embodiments of the invention may allow for improved pixel grid homogeneity.

In embodiments of the invention, the positions of the individual lenticular lenses may be adjusted in a direction perpendicular to the plane of the view forming module (i.e. the z direction) to provide the lenses with equal widths. In this way, the brightness non-uniformity reducing function of the view forming module may be maximised.

As an alternative to lenticular lenses, the view forming elements may be other lens elements, for example each defined by a composite arrangement of sub-lenticular lenses. In these embodiments, the geometric axes of the sub-lenticular lenses of each lens element may have different positions in the width direction of the display device. The periodic inter-element variation may then include a variation in the relative positions, in the width direction of the display device, of the geometric axes of the sub-lenticular lenses relative to one another.

In all of the embodiments of the invention, a small quasi-random component of inter-element variation may be added to the periodic inter-element variation described above. The quasi-random component of variation may serve to minimise any residual brightness non-uniformities.

According to another aspect of the invention, there is provided a multi-view auto stereoscopic display device comprising:

an image forming means having a planar array of light emissive display pixels arranged in rows and columns for producing a display, the display pixels being spatially defined by an opaque matrix; and

the view forming module described above, arranged over and in registration with the image forming means.

The array of display pixels of the image forming means may be arranged in an orthogonal row and column array, or in other suitable arrangements. For example, the display pixels may have a hexagonal arrangement addressed by rows and columns of electrodes.

The display device may further comprise a driving means arranged to drive the image forming means with video data for the plurality of views. For example, the driving means may be arranged to drive each group of display pixels adjacent to each view forming element with video data for the plurality of views.

According to yet another aspect of the invention there is provided a multi-view auto stereoscopic imaging method comprising:

forming an image using a planar array of light emissive display pixels arranged in rows and columns, the display pixels being spatially defined by an opaque matrix; and forming the image into a plurality of views projected towards a user in respective different directions using a plurality of view forming elements arranged across the array of display pixels, each view forming element focusing the light output from adjacent groups of the display pixels into the plurality of views, wherein the geometry of the groups of display pixels defines a substantially periodic inter-group variation and/or the geometry of the view forming elements defines a substantially periodic inter-element variation in the width direction of the array of display pixels, for reducing brightness non-uniformities in the views.

According to yet another aspect of the invention there is provided a multi-view auto stereoscopic display device comprising:

an image forming means having a planar array of light emissive display pixels arranged in rows and columns for producing a display, the display pixels being spatially defined by an opaque matrix; and

a view forming module arranged over and in registration with the image forming means, the view forming module being configurable to function as a plurality of view forming elements arranged in the width direction of the display device, each view forming element focusing the light output from an adjacent group of the display pixels into a plurality of views for projection towards a user in respective different directions,

wherein the geometry of the groups of display pixels defines a substantially periodic inter-group variation in the width direction of the display device, for reducing brightness non-uniformities in the views.

According to this aspect of the invention, brightness non-uniformities are reduced, for example, by varying the location, width and/or spacing of the display pixels arranged in registration with the view forming module. In a specific embodiment, display pixels underlying “odd” and “even” view forming elements are shifted slightly to the left and right, respectively, as compared to their positions in a regular array of display pixels.

A number of other approaches have been proposed for reducing the amplitude of the non-uniformities. For example, the amplitude of the non-uniformities can be reduced by the well known technique of slanting the lenticular lenses at an acute angle relative to the column direction of the display pixel array. This technique also enables the “resolution loss” introduced by providing multiple views to be distributed between the horizontal and vertical directions of the display. In certain instances it remains difficult, however, to reduce the intensity modulation depth introduced by imaging the black matrix to a level below which the non-uniformities remain perceivable and distracting for a user.

Another approach for reducing the amplitude of the non-uniformities is the so-called fractional view arrangement, which is described in detail in WO 2006/117707 A2. Devices having a fractional view arrangement are characterised in that the pitch of the slanted lenticular lenses is not equal to an integer number times the pitch of the display pixels (i.e. the sub-pixel pitch in a colour display), and in that the pixels under successive lenticular lenses are positioned in a horizontally alternating fashion. As a result, the successive lenses simultaneously project different amounts of the black matrix, leading to intensity modulations which are mutually shifted in phase. The first harmonic of the total intensity cancels out, leaving a much less intense non-uniformity effect. According to this approach, the intensity modulation depth introduced by imaging the black matrix may be reduced significantly. Rendering of the views is, however, required.

It has also been found that the intensity of the non-uniformities introduced by imaging the black matrix in the above described devices varies as a function of the focusing power of the lenticular lenses. In general, defocusing the lenses in a device by increasing their focal length causes a reduction in the intensity modulation depth introduced by imaging the black matrix. However, defocusing the lenses also gives rise to some cross-talk between the views projected by the lenticular lenses, which may be detrimental to the three dimensional effect perceived by the user.

### BRIEF DESCRIPTION OF THE DRAWINGS

Embodiments of the invention will now be described, purely by way of example, with reference to the accompanying drawings, in which:

FIG. 1 is a schematic perspective view of an autostereoscopic display device;

FIG. 2 is a schematic cross sectional view of the display device shown in FIG. 1 for explaining its mode of operation;

FIGS. 3A, 3B and 3C are diagrams for explaining techniques for reducing brightness non-uniformities in the output of the display device shown in FIG. 1;

FIGS. 4A, 4B and 4C are cross-sectional views of first, second and third view forming modules according to the invention;

FIGS. 5A, 5B and 5C illustrate the reduction of brightness non-uniformities in the output of an autostereoscopic display device using the view forming module shown in FIGS. 4A;

FIGS. 6A and 6B are schematic cross-sectional views of fourth and fifth view forming modules according to the invention.

FIGS. 7A and 7B are simulations of a pixel grid arrangement of one of the views projected by an autostereoscopic display device using the fourth and fifth view forming modules shown in FIGS. 6A and 6B, respectively;

FIG. 8 is a schematic cross-sectional view of a sixth view forming module according to the invention;

FIG. 9 is a simulation result for an autostereoscopic display device using the sixth view forming module shown in FIG. 8;

FIG. 10 is a diagram for illustrating the geometry of a seventh view forming module according to the invention; and

FIG. 11 is a simulation result for an autostereoscopic display device using the seventh view forming module shown in FIG. 10.

### DETAILED DESCRIPTION OF EMBODIMENTS

The invention provides an autostereoscopic display device of the type that has an image forming means and a view forming module. The autostereoscopic device may be a multi view display, giving a look around impression of image objects. The image forming means may be any image forming means envisaged that is suitable for display of an image. Preferably the way in which output of the pixels is provided by the image forming means does not require illumination of the pixels through the view forming module. Preferably the image forming means is an active image forming means such as an electrical display device where the pixels provide output without external input. Such means include but are not limited to cathode ray tubes, plasma display panels, liquid crystal displays or light emitting diode displays. In these cases, the output of the display pixels is not dependent on external illumination. The device may also have a driving means arranged to drive the image forming means with video data for the plurality of views.

The image forming means has a planar array of light emissive display pixels arranged in rows and columns for producing a display, with the display pixels being spatially defined by an opaque matrix,

The view forming module is arranged over and in registration with the image forming means and functions as a plurality of view forming elements arranged in the width direction of the display device. Each view forming element focuses the light output from an adjacent group of the display pixels into a plurality of views for projection towards a user in respective different directions. According to the invention, the geometry of the view forming elements defines a substantially periodic inter-element variation in the width direction of the display device, for reducing brightness non-uniformities in the views.

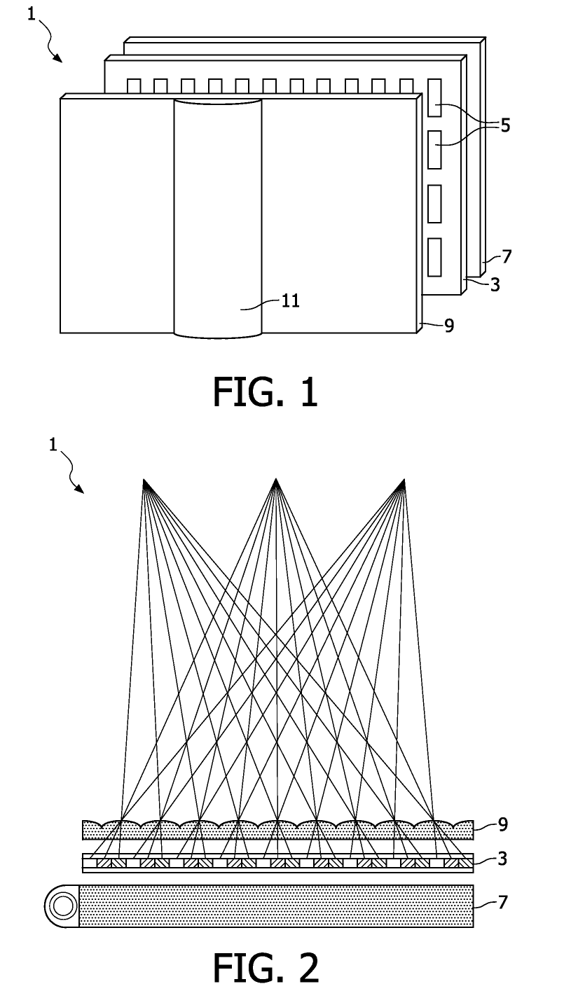

FIG. 1 is a schematic perspective view of a known multi-view autostereoscopic display device 1. The known device 1 comprises a liquid crystal display panel 3 of the active matrix type that acts as an image forming means to produce the display.

The display panel 3 has an orthogonal array of display pixels 5 arranged in rows and columns. For the sake of clarity, only a small number of display pixels 5 are shown in the figure. In practice, the display panel 3 might comprise about one thousand rows and several thousand columns of display pixels 5.

The structure of the liquid crystal display panel 3 is entirely conventional. In particular, the panel 3 comprises a pair of spaced transparent glass substrates, between which an aligned twisted nematic or other liquid crystal material is provided. The substrates carry patterns of transparent indium tin oxide (ITO) electrodes on their facing surfaces. Polarising layers are also provided on the outer surfaces of the substrates.

Each display pixel 5 comprises opposing electrodes on the substrates, with the intervening liquid crystal material therebetween. The shape and layout of the display pixels 5 are determined by the shape and layout of the electrodes and a black matrix arrangement provided on the front of the panel 3. The display pixels 5 are regularly spaced from one another by gaps.

Each display pixel 5 is associated with a switching element, such as a thin film transistor (TFT) or thin film diode (TFD). The display pixels are operated to produce the display by providing addressing signals to the switching elements, and suitable addressing schemes will be known to those skilled in the art.

The display panel 3 is illuminated by a light source 7 comprising, in this case, a planar backlight extending over the area of the display pixel array. Light from the light source 7 is directed through the display panel 3, with the individual display pixels 5 being driven to modulate the light and produce the display.

The display device 1 also comprises a lenticular sheet 9, arranged over the display side of the display panel 3, which performs a view forming function. The lenticular sheet 9 comprises a row of lenticular lenses 11 extending parallel to one another in the column direction of the display panel 3, of which only one is shown with exaggerated dimensions for the sake of clarity. The lenticular lenses 11 have focal points which approximately coincide with a plane of the display panel 3 and act as view forming elements to perform a view forming function.

The lenticular lenses 11 are in the form of convex cylindrical elements, and they act as a light output directing means to provide different images, or views, from the display panel 3 to the eyes of a user positioned in front of the display device 1.

The lenticular sheet 9 is formed as a replicated lens structure, as is known in the art. The planar surfaces of the lenses 11 are bounded by a glass substrate (not shown) which provides rigidity. The convex surfaces of the lenses 11 are bounded by a silicone filler (not shown), which filler is disposed between the lenticular lenses 11 and another glass substrate (not shown).

The autostereoscopic display device 1 shown in FIG. 1 is capable of projecting several different perspective views in different directions. In particular, each lenticular lens 11 overlies a small group of display pixels 5 in each row. The lenticular lens 11 projects each display pixel 5 of a group in a different direction, so as to form the several different views. As the user's head moves from left to right, his/her eyes will receive different ones of the several views, in turn.

FIG. 2 shows the principle of operation of a lenticular type imaging arrangement as described above and shows the light source 7, display panel 3 and the lenticular sheet 9. The arrangement provides three views each projected in different directions. Each pixel of the display panel 3 is driven with information for one specific view.

The above described autostereoscopic display device produces a display having good levels of brightness. However, a problem associated with the device is that the views projected by the lenticular sheet 9 are separated by dark zones caused by imaging of the non-emitting black matrix which defines the display pixel array. These dark zones are readily observed by a user as brightness non-uniformities in the form of dark vertical bands spaced across the display. The bands move across the display as the user moves from left to right and the pitch of the bands changes as the user moves towards or away from the display. The bands are particularly problematic in devices having a high proportion of their display area as black matrix, such as high resolution displays designed for mobile applications.

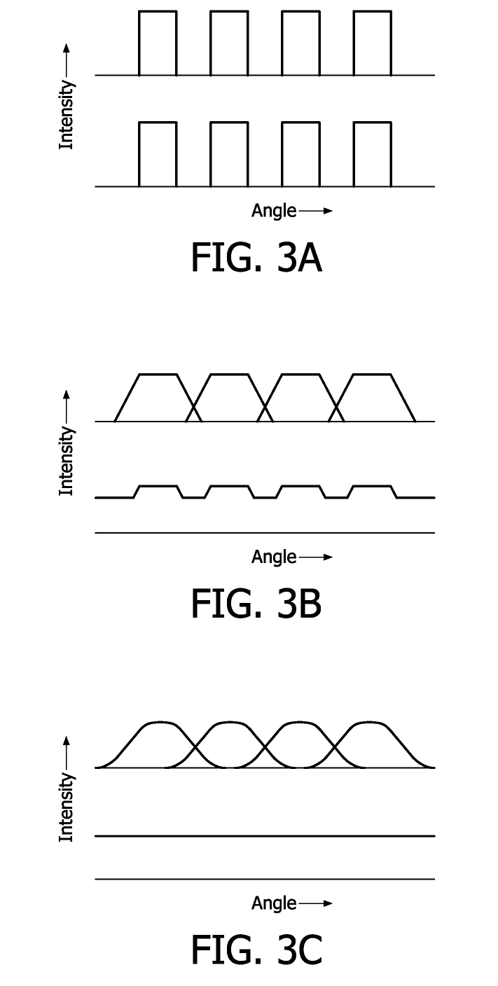

The brightness non-uniformities caused by imaging of the black matrix are illustrated in FIG. 3A, which shows generalised plots of brightness intensity against viewing angle for the display device shown in FIGS. 1 and 2. The upper plot shows the contributions of the individual views, which contributions each have constant brightness intensity, interposed between the dark bands caused by imaging of the black matrix, which bands each have zero brightness intensity. The transition between views and dark bands is a step transition. The lower plot shows the cumulative effect of the contributions of the individual views, that is to say the brightness levels observed by the user moving across the front of the display. It can be seen from the lower plot that there is a significant modulation of the brightness intensity.

A number of approaches have been proposed for reducing the amplitude of the non-uniformities. For example, the amplitude of the non-uniformities can be reduced by the well known technique of slanting the lenticular lenses 11 at an acute angle relative to the column direction of the display pixel array. The resulting brightness non-uniformities are illustrated in FIG. 3B. In this Fig., the upper plot again shows the contributions of the individual views interposed between the dark bands caused by imaging of the black matrix. It can be seen that the transition between views and dark bands is gradual, with the brightness intensity changing at a constant rate. The lower plot shows the cumulative effect of the contributions of the individual views, and it can be seen that the intensity modulation depth introduced by imaging the black matrix is significantly reduced. However, it remains difficult to reduce this intensity modulation depth to below 1%, at which level the non-uniformities remain perceivable and distracting for a user.

Although the technique of slanting the lenticular lenses 11 may serve to reduce the perceived brightness non-uniformities caused by imaging of the black matrix, further significant reductions can advantageously be achieved by defocusing the lenticular lenses 11. According to this technique, the focal lengths of the lenticular lenses 11 are extended so that their focal points lie behind the plane of the display panel 3. The resulting brightness non-uniformities are illustrated in FIG. 3C. In the upper plot, it can be seen that the transition between views and dark bands is gradual, with intensity changing at a varying rate. The lower plot shows the cumulative effect of the contributions of the individual views, and it can be seen that the intensity modulation depth introduced by imaging the black matrix is almost completely eliminated.

The further reduction in the brightness non-uniformities obtained by defocusing the lenticular lenses 11 comes at the expense of introducing some cross-talk between the views, which is detrimental to the perceived three dimensional performance of the device. This cross-talk generally increases as the lenticular lenses 11 are defocused.

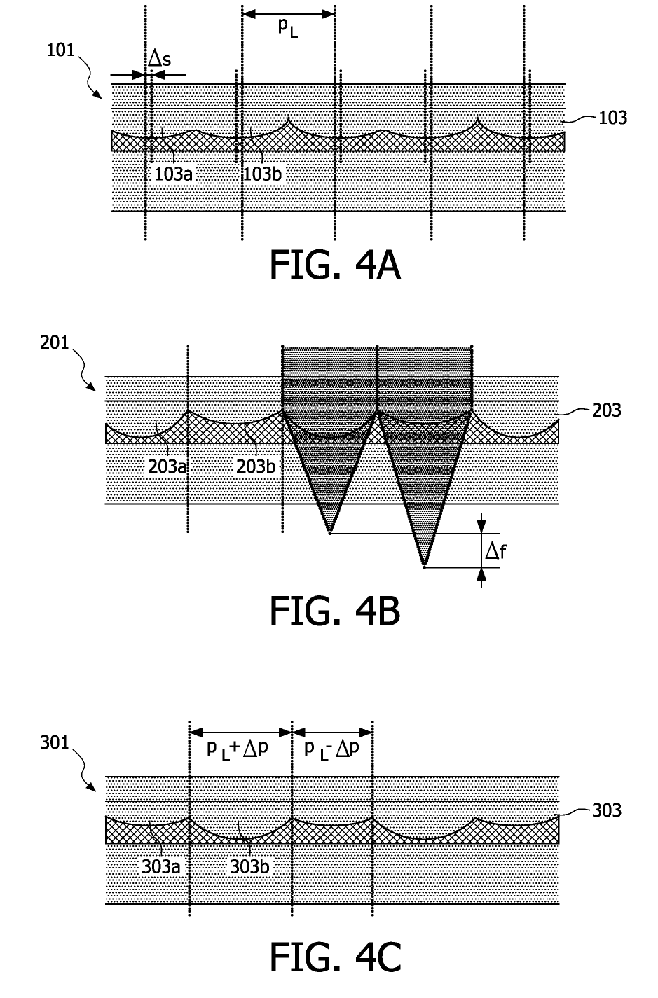

FIGS. 4A, 4B and 4C are schematic cross-sectional views of first, second and third view forming modules 101, 201, 301 according to the invention.

Each of the view forming modules according to the invention has a design and structure similar to that of the lenticular sheet 9 described above with reference to FIGS. 1 and 2. In particular, the view forming modules 101, 201, 301 are adapted to be used with an image forming means in the form of a liquid crystal display panel to form an auto stereoscopic display device.

Thus, each of the view forming modules 101, 201, 301 is formed as a replicated lens structure. The lens structure defines a plurality of individual lenticular lenses 103, 203, 303 arranged as an array in the width direction of the display device.

The lenticular lenses 103, 203, 303 are arranged at an acute angle (i.e. slanted) with respect to a direction perpendicular to the width of the display device. Herein, in the context of a lenticular lens, the expression “geometric axis” refers to the longitudinal axis which defines the centre of curvature of the lens surface.

The lenticular lenses 103, 203, 303 are sandwiched by a glass substrate and a silicone filler layer. The glass substrate bounds the planar surfaces of the lenticular lenses 103, 203, 303, and provides the view forming module 101, 201, 301 with rigidity. The silicone filler layer bounds the curved surfaces of the lenses 103, 203, 303 and is adapted to be coupled to an image forming means in the form of a liquid crystal display panel (not shown), via a glass substrate spacing means. In other view forming modules according to the invention, the silicone filler layer may be omitted, at least until the module is coupled to an image forming means. The basic structure of the view forming module 101, 201, 301, and its manufacture, will be known to those skilled in the art.

Each of the view forming modules 101, 201, 301 according to the invention differs from the lenticular sheet 9 shown in FIGS. 1 and 2 in that the geometry of the lenses 103, 203, 303 defines a substantially periodic inter-lens variation in the width direction of the display device, which is provided for reducing brightness non-uniformities in the views. In other words, successive lenses 103, 203, 303 in the view forming module 101, 201, 301 have different geometries, and these differences define a periodicity.

The inter-lens variation in the geometry of the lenses 103, 203, 303 is described as “substantially” periodic in the sense that a small quasi-random component of inter-lens variation may also be present for the purpose of minimising any residual brightness non-uniformities. However, the quasi random component of inter-lens variation may be omitted so that the inter-lens variation is wholly periodic in character.

In the first view forming module 101 according to the invention, the above-mentioned inter-lens variation is a variation in the positions, in the width direction of the display device, of the geometric axes of the lenticular lenses 103 relative to their longitudinal centrelines. Herein, in the context of a lenticular lens, the expression “longitudinal centreline” refers to a line which passes through the lateral midpoints of the lens.

The inter-lens variation of the first view forming module 101 has a period corresponding to two lenses 103. The variation is effectively obtained by displacing “odd” lenses 103a slightly in the right direction of the display device and by displacing “even” lenses 103b slightly in the left direction of the display device, as compared to the regular array of identical lenticular lenses 11 shown in FIGS. 1 and 2. Thus, the lateral cross-sections of the individual lenses 103 can be seen to be asymmetrical.

The view forming module 101 shown in FIG. 4A is specifically adapted for use in a nine-view autostereoscopic display device. The lenticular lenses 103 are in this case arranged to define an acute angle with the column direction of the display panel of tan•=⅙, and have a pitch of 4.5 sub-pixels. The displacement of the geometric axes relative the longitudinal centrelines is given by the following equation:

$$Δ s = \pm \frac{1}{8} {p}_{p} = \pm \frac{1}{36} {p}_{L} \qquad ( 1 )$$

where pₚ is the sub-pixel pitch of the image forming means, p_{L} is the pitch of the lenticular lenses.

In the second view forming module 201 according to the invention, the above-mentioned inter-lens variation is a variation in the focusing power of the lenticular lenses 203, as measured by the focal length f of the lenses. The variation has a period corresponding to two lenses. The variation in focusing power is obtained by varying the radii of curvature of the lenses 203, although in other embodiments the variation in focusing power could also be provided by varying the refractive indices of the media which define the lenses 203, i.e. the replicated lens structure and the silicone filler layer. The widths of the lenses 203 are the same.

The focal lengths of the lenses 203 may be calculated by the following equation:

$$\frac{1}{f} \approx \frac{{n}_{1} - {n}_{2}}{{n}_{0}} \cdot \frac{1}{R} \qquad ( 2 )$$

where f is the focal length of the lens 203, n₀, n₁ and n₂ are the indices of refraction of the glass spacer and glass substrate bounding the planar surfaces of the lenses, the replicated lens structure, and the silicone filler layer, respectively, and R is the radius of curvature of the lens 203.

The average focal length of the lenticular lenses 203 is selected to substantially correspond to the distance between the planes of the image forming means and the view forming module 201. In the embodiment shown, the focal lengths of the individual lenses 203 differ from the average focal length by 5%. Thus, in use of the view forming module 201 with an image forming means, the “odd” lenses 203a have focal points which are positioned directly in front of the plane of the image forming means and the “even” lenses 203b have focal points which are positioned directly behind the plane of the image forming means.

In the third view forming module 301 according to the invention, the above-mentioned inter-lens variation is a variation in the width of the lenticular lenses 303. The variation has a period corresponding to two lenses.

In the embodiment shown, the widths of the individual lenses 303 differ from the average lens width p_{L} by an amount •p of 5%. Thus, the “odd” lenses 303a have widths equal to p_{L}−p and the “even” lenses 303b have widths equal to p_{L}+•p.

In use of each of the first, second and third view forming modules 103, 203, 303 according to the invention, the module 101, 201, 301 is arranged over and in registration with an image forming means, in a similar arrangement to that of the lenticular sheet 9 shown in FIGS. 1 and 2. The arrangement of the view forming module 101, 201, 301 differs from that of the lenticular sheet 9 shown in FIG. 2 only in that, according to the invention, the curved surfaces of the lenses of the view forming module 101, 201, 301 face towards the image forming means.

The display pixels of the image forming means are then driven with display data for a plurality of views, and the plurality of views are projected in different directions by the view forming module 101, 201, 301. In particular, a group of the display pixels adjacent to each lenticular lens 103, 203, 303 is driven with display data for the plurality of views, and each lens 103, 203, 303 projects a portion of each view in a respective direction to enable multiple stereoscopic images to be viewed by a user.

The inter-lens variation in the view forming module 101, 201, 301 causes the same views projected by successive lenses 103, 203, 303 to be projected differently. For example, the inter-lens variation in the first view forming module 101 causes the same views projected in slightly different directions. In this way, the brightness non-uniformities are projected by each lens 103, 203, 303 in a slightly different manner, with the effect that the non-uniformities are less noticeable so that an improved three dimensional effect may be perceived by the user.

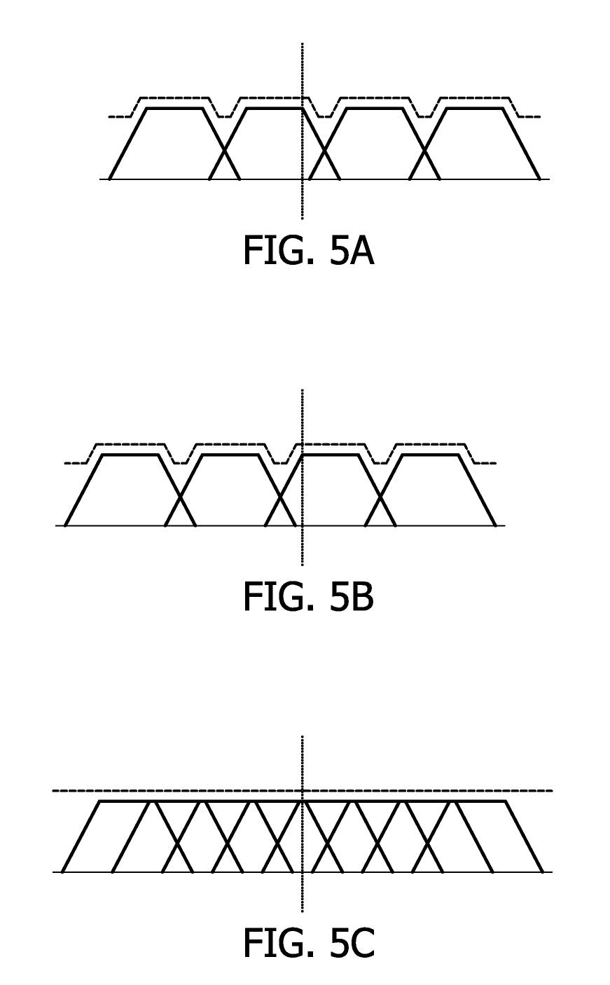

The brightness non-uniformities arising when the first view forming module 103 is used in an autostereoscopic display device of the type shown in FIGS. 1 and 2 are illustrated schematically in FIGS. 5A, 5B and 5C.

FIGS. 5A is a plot illustrating the angular distribution of brightness intensity arising from the views projected by the “odd” lenses 103a of the view forming module 101. FIGS. 5B is a plot illustrating the angular distribution of brightness arising from the views projected by the “even” lenses 103b of the view forming module 101. In each case, it can be seen that the transition between views and dark bands between views is gradual. The gradual transitioning is a consequence of the slanted arrangement of the lenses 103 as explained above. The broken line in each of the Figs. represents the cumulative effect of the contributions of the individual views.

It can be clearly seen in FIGS. 5A and 5B that the brightness non-uniformities introduced by imaging of the black matrix are not entirely eliminated. However, it can also be seen that the brightness non-uniformities illustrated in FIGS. 5A and 5B are 180 degrees out of phase with respect to each other. This phase relationship is a consequence of the periodic inter-lens variation in the geometry of the lenses.

FIG. 5C is a plot illustrating the combined angular distribution of brightness intensities illustrated in FIGS. 5A and 5B, that is to say the angular distribution of brightness arising from the “odd” and the “even” lenses 103. Again, the broken line in the Fig. represents the cumulative effect of the contributions of the individual views, that is to say the brightness levels observed by a user moving across the front of the display.

It can be clearly seen in FIG. 5C that the periodic variation in the distribution of brightness intensity is very significantly reduced. In particular, the main frequency component of the brightness non-uniformities is eliminated, leaving only higher order frequency components which have a much smaller intensity depth.

The reduction in the brightness non-uniformities obtained by varying the geometry of the lenticular lenses according to the invention comes at the expense of introducing some cross-talk between the views, which cross-talk is detrimental to the perceived three dimensional performance of the device. However, the contrast of the display device is not affected, and the complexity of the device is not affected in the sense that additional layers or components are not required. The increase in cross-talk can be avoided by additional processing of the display data with which the image forming means is driven.

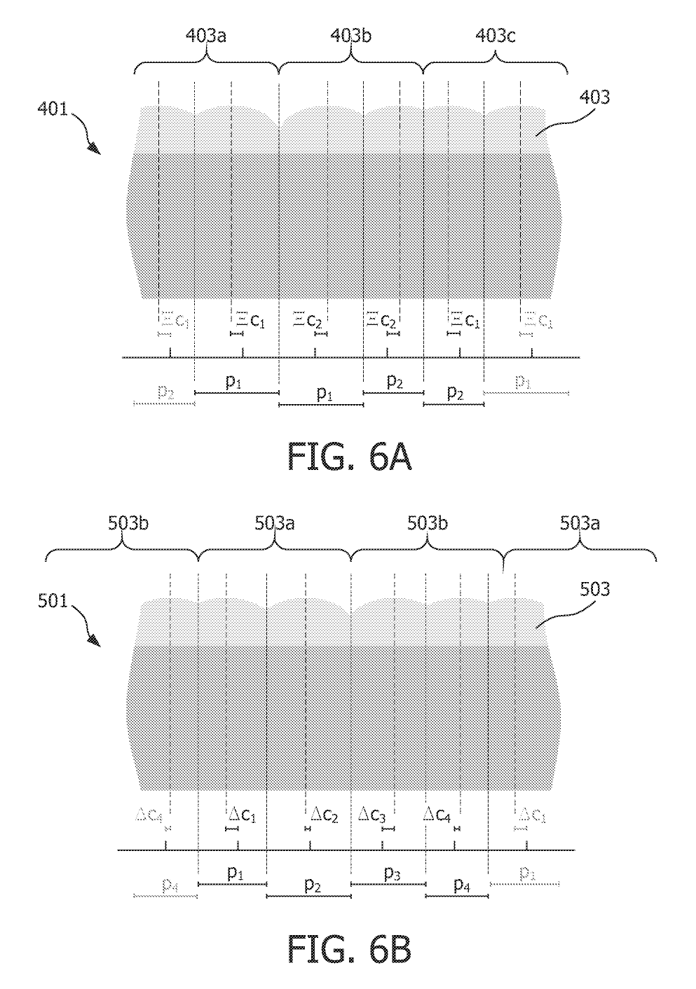

FIGS. 6A and 6B are schematic cross-sectional views of fourth and fifth view forming modules 401, 501 according to the invention.

The fourth and fifth view forming modules 401, 501 according to the invention each has a design and structure similar to that of the first view forming module 101 described above with reference to FIG. 4A. In particular, the view forming modules 401, 501 comprise lenticular lenses 403, 503 and are adapted to be used with an image forming means to form an autostereoscopic display device.

Each of the fourth and fifth view forming modules 401, 501 according to the invention differs from the first view forming module 101 shown in FIG. 4A in the configuration of the inter-lens variation of the geometry of the lenses. In particular, in the fourth and fifth view forming modules 401, 501, the geometric axes of the lenticular lenses 403, 503 have different positions, in the width direction of the display device, relative to their longitudinal centrelines.

The inter-lens variation of the fourth view forming module 401 according to the invention has a period corresponding to four lenses 403. The variation is effectively obtained by displacing “odd” pairs of lenses 403a slightly in the left direction of the display device and by displacing “even” pairs of lenses 403b slightly in the right direction of the display device, as compared to the regular array of identical lenticular lenses 11 shown in FIGS. 1 and 2.

The “odd” pairs of lenses 403a are displaced in the left direction of the display device by a first displacement •c₁ and the “even” pairs of lenses 403b are displaced in the right direction by a second displacement •c₂, where •c₁=c₂.

In each of the “odd” and “even” pairs of lenses 403a, 403b of the fourth view forming module 401, a first one of the lenses has a larger width p₁ and a second one of the lenses has a smaller width p₂. The lenses 403 are arranged such that points on the surfaces of the lenticular lenses 403 having positions, in the width direction of the display device, corresponding to the geometric axes of the lenses (indicated by the intersections of broken lines with the lens surfaces), define a common plane.

The fourth view forming module 401 provides similar advantages to those of the first view forming module 101 shown in FIG. 4A. However, the fourth view forming module 401 more effectively minimises the brightness non-uniformities, since it not only operates to minimise the main frequency component of the non-uniformities (which is also minimised by the first view forming module 101), but also minimises other, higher frequency components of the non-uniformities.

The inter-lens variation of the fifth view forming module 501 according to the invention also has a period corresponding to four lenses 503, as illustrated in FIG. 6B. Again, the variation is effectively obtained by displacing “odd” pairs of lenses 503a slightly in the left direction of the display device and by displacing “even” pairs of lenses 503b slightly in the right direction of the display device, as compared to the regular array of identical lenticular lenses 11 shown in FIGS. 1 and 2.

The lenses of “odd” pairs of lenses 503a are displaced in the left direction of the display device by different amounts •c₁ and •c₂, where •c₁>•c₂. The lenses of the “even” pairs of lenses 503b are displaced in the right direction by different amounts •c₃ and •c₄, where •c₃>•c₄. Also, •c₁=•c₃ and •c₂=•c₄. The optimal amounts for the displacement of the lenses are determined by the angle of the lenticular lenses 503 with respect to the column direction of the image forming means with which the fifth view forming module 501 is used. The fifth view forming module 501 is adapted for use in an autostereoscopic display device in which the lenticular lenses 503 define an angle with the column direction of the image forming means of tan •=⅙, so that:

•c₁=•c₃=0.25 pₚ

•c₂=•c₄=0.125 pₚ

where pₚ is the sub-pixel pitch of the image forming means.

The lenses of the “odd” and “even” pairs of lenses 503a, 503b of the fifth view forming module 501 have different widths p₁, p₂, p₃, and p₄. The lenses 503 are arranged such that points on the surfaces of the lenticular lenses 503 having positions, in the width direction of the display device, corresponding to the geometric axes of the lenses (indicated by the intersections of broken lines with the lens surfaces), define a plane.

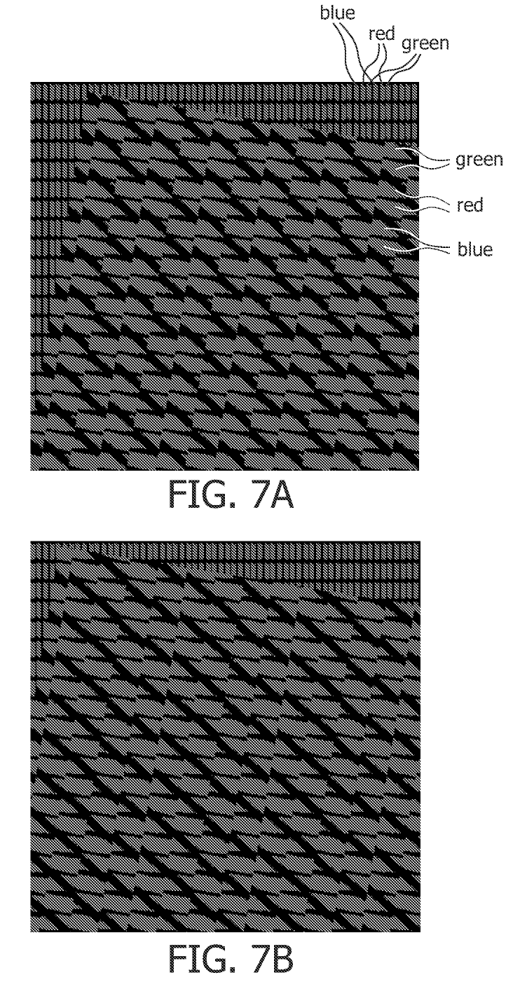

The fifth view forming module 501 provides similar advantages to those of the fourth view forming module 401 shown in FIG. 6A. However, the fifth view forming module 501 additionally provides an autostereoscopic display device with improved pixel grid homogeneity. The improved pixel grid homogeneity is illustrated in FIG. 7A and 7B, which are simulations of pixel grid arrangements of views projected by autostereoscopic display devices using the fourth and fifth view forming modules 401, 501 shown in FIGS. 6A and 6B, respectively. It will be seen that the pixel grid shown in FIG. 7A has a distinctive horizontal line pattern, which is caused by rows of the same colour sub-pixels being alternately shifted upwards and downwards. The horizontal line pattern is not present in the pixel grid shown in FIG. 7B.

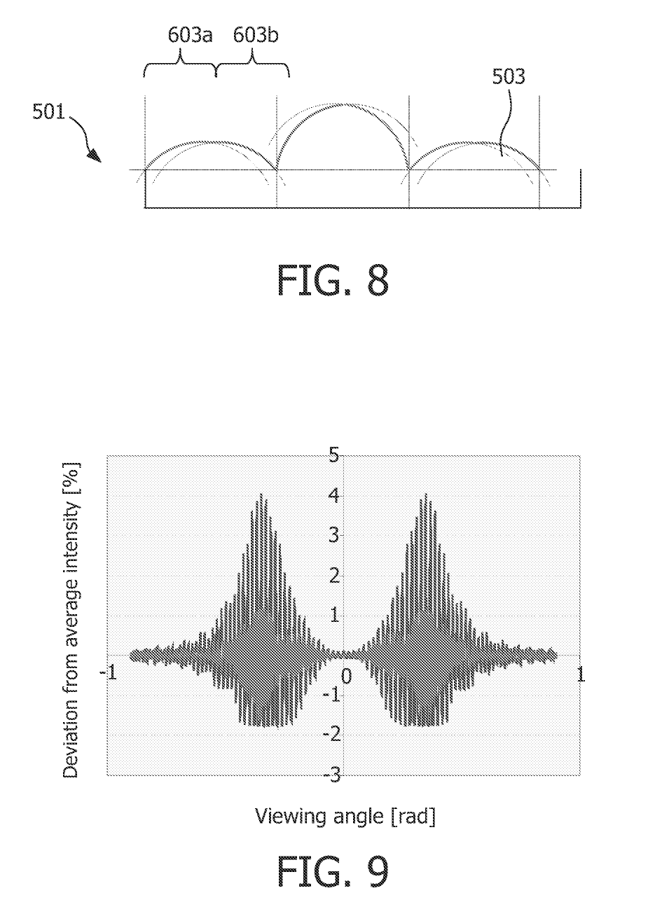

FIG. 8 is a schematic cross-sectional view of a sixth view forming module 601 according to the invention. The sixth view forming module 601 differs from the view forming modules described above in that the view forming elements are not in the form of normal lenticular lenses. Instead, the view forming elements of the sixth view forming module 601 in the form of composite lenses 603 each comprise a pair of sub-lenticular lenses.

In particular, each lens 603 of the sixth view forming module 601 is split into two sub-lenses of equal width: a left sub-lens 603a and a right sub-lens 603b. The left and right sub-lenses 603a, 603b of each lens differ from each other in that the positions, in the width direction of the display device, are displaced in different directions with respect to the longitudinal centrelines of the lenses 603.

The inter-lens variation of the sixth view forming module 601 according to the invention has a period corresponding to two lenses 603. The inter-element variation is provided by varying the relative positions, in the width direction of the display device, of the geometric axes of the sub-lenticular lenses. Thus, in the “odd” composite lenses, the geometric axis of the left sub-lenticular lens 603a is positioned to the left of the lens centreline and the geometric axis of the right sub-lenticular lens 603b is positioned to the right of the lens centreline. In contrast, in the “even” composite lenses, the geometric axis of the left sub-lenticular lens 603a is positioned to the right of the lens centreline and the geometric axis of the right sub-lenticular lens 603b is positioned to the left of the lens centreline lenses.

The sixth view forming module 601 provides similar advantages to those of the view forming modules described above. In particular, an autostereoscopic display device comprising the sixth view forming module 601 projects views in which the levels of brightness non-uniformities are significantly reduced. This reduction in the levels of brightness non-uniformities is illustrated in FIG. 9, which shows simulation results for autostereoscopic display devices using the sixth view forming module 601.

The core shaded portion 605 of FIG. 9 represents the extent of the brightness non-uniformities projected by an autostereoscopic display device using the sixth view forming module 601. For comparison purposes, the vertical striped portion 607 of FIG. 9 represents the extent of the brightness non-uniformities of an autostereoscopic display device of the type shown in FIGS. 1 and 2.

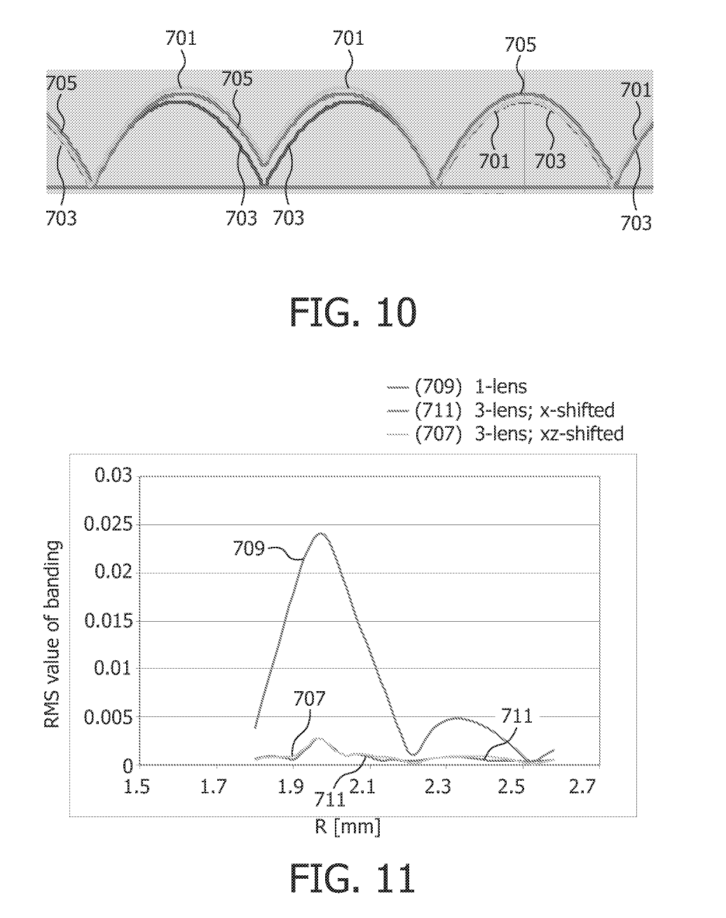

FIG. 10 is a diagram for illustrating the geometry of a seventh view forming module according to the invention. The seventh view forming module according to the invention has a design and structure similar to that of first view forming module 101 described above with reference to FIG. 4A. In particular, the seventh view forming module comprises lenticular lenses and is adapted to be used with an image forming means to form an autostereoscopic display device.

The seventh view forming module according to the invention differs from the first view forming module 101 shown in FIG. 4A in the configuration of the inter-lens variation of the geometry of the lenses. In particular, in the seventh view forming module, the geometric axes of the lenticular lenses have different positions, in the width direction of the display device, relative to their longitudinal centrelines.

The inter-lens variation of the seventh view forming module according to the invention has a period corresponding to three lenses. The variation is effectively obtained by displacing a first lens in each triplet of lenses slightly in the left direction (Δs=−p_{L}/27), a second lens in each triplet slightly in the right direction (Δs=p_{L}/27) of the display device, and by leaving a third lens in each triplet undisplaced (Δs=0), as compared to the regular array of identical lenticular lenses 11 shown in FIGS. 1 and 2. As well as displacing lenses in the left-right direction of the display device, the lenses are selectively displaced in a direction perpendicular to the plane of the view forming module to provide the lenses with identical widths.

The geometry of the lenses of the seventh view forming module is illustrated in FIG. 10. In the Fig., a first line 701 illustrates the geometry of the lenses of the seventh view forming module (i.e. lenses displaced in x and z directions). For comparison purposes, a second line 703 illustrates the geometry of the lenses of a view forming module of the type shown in FIGS. 1 and 2 (i.e. no displacement of lenses), and a third line 705 illustrates the geometry of the lenses of a view forming module similar in configuration to the seventh view forming module, but without the lenses having been displaced in the direction perpendicular to the plane of the view forming module (i.e. displaced in the x direction only).

The seventh view forming module provides similar advantages to those of the first view forming module 101 shown in FIG. 4A. However, the seventh view forming module more effectively minimises the brightness non-uniformities, since it not only operates to minimise the main frequency component of the non-uniformities (which is also minimised by the first view forming module 101), but also minimises other, higher frequency components of the non-uniformities.

FIG. 11 is a simulation result for an autostereoscopic display device using the seventh view forming module shown in FIG. 10.

A first line 707 indicates, for different lens radii, the level of brightness non-uniformities projected by an autostereoscopic display device using the seventh view forming module. For comparison purposes, a second line 709 indicates the level of brightness non-uniformities projected by an autostereoscopic display device using a view forming module of the type shown in FIGS. 1 and 2 (i.e. no displacement of lenses), and a third line 711 shows the level of brightness non-uniformities projected by an autostereoscopic display device using a view forming module similar in configuration to the seventh view forming module, but without the lenses having been displaced in the direction perpendicular to the plane of the view forming module (i.e. displaced in the x direction only).

With reference to FIG. 11, it will be seen that the levels of brightness non-uniformities are minimal for lens radii of approximately 2.21 mm. It will also be seen that the level of the brightness non-uniformities for the seventh view forming module is significantly lower than it is for the view forming module having lenses displaced in the left-right direction of the display device only (i.e. displaced in the x direction only). The superior performance of the seventh view forming module is attributable to the fact that the lenses of the seventh view forming module have been adjusted in the direction perpendicular to the plane of the view forming module so that they have equal widths, whereas the view forming module having lenses displaced in the left-right direction of the display device only (i.e. displaced in the x direction only) has lenses with slightly different widths. A slight difference in the widths of the lenses has been found to cause an imbalance in the intensity contributions of the lenses, which prevents optimal compensation of the brightness non-uniformities.

Preferred embodiments of the invention have been described above. However, it will be understood by those skilled in the art that various changes and modifications may be made without departing from the scope of the invention.

For example, the embodiment described above employs a lenticular sheet as a view forming layer. However, another view forming layer may be used, such as a barrier layer having an array of elongate light transmissive slits.

The image forming means in the embodiment described above is a liquid crystal display panel. However, other forms of image forming means may be employed.

In the embodiments described above, brightness non-uniformities are reduced by varying the geometry of the view forming elements. In other embodiments, brightness non-uniformities may be reduced by alternatively or additionally providing the geometry of the groups of display pixels of the image forming means with a substantially periodic inter-group variation in the width direction of the display device. In one such embodiment, a display device would be similar to that shown in FIGS. 1 and 2, except that display pixels underlying “odd” and “even” lenses would be shifted slightly to the left and right, respectively, as compared to their positions in a regular array of display pixels.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

In summary, there is disclosed an autostereoscopic display device comprising an image forming means arranged over and in registration with a view forming module. The image forming means has a planar array of light emissive display pixels arranged in rows and columns for producing a display. The image forming means may, for example, be a LCD display panel. The view forming module is configurable to function as a plurality of view forming elements arranged in the width direction of the display device, each view forming element focusing the light output from an adjacent group of the display pixels into a plurality of views for projection towards a user in respective different directions. The view forming module may, for example, be an array of lenticular lenses. The geometry of the view forming elements defines a substantially periodic inter-element variation in the width direction of the display device, for reducing brightness non-uniformities in the views. The inter-element variation may, for example, be provided by varying at least one of the widths, the focusing powers and the relative positions of the geometric axes of the lenticular lenses in the width direction of the display device.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that the combination of these measures cannot be used to advantage.

1. A view forming module for arrangement over and in registration with an image forming means of an autostereoscopic display device, the image forming means having a planar array of display pixels arranged in rows and columns for producing a display,
the view forming module being configurable to function as a plurality of view forming elements (103a, 103b) arranged in the width direction of the autostereoscopic display device, each view forming element directing the light output from an adjacent group of the display pixels into a plurality of views for projection towards a user in respective different directions,
wherein the geometry of the view forming elements (103a, 103b) defines a substantially periodic inter-element variation in the width direction of the display device, for reducing brightness non-uniformities in the views.

2. A view forming module according to claim 1, configurable to function as a plurality of lenticular lenses (103a, 103b), wherein each lens defines one of the view forming elements.

3. A view forming module according to claim 2, wherein the periodic inter-element variation includes a variation in the widths of the lenticular lenses.

4. A view forming module according to claim 2, wherein the periodic inter-element variation includes a variation in the focusing powers of the lenticular lenses provided by varying at least one of the radii of curvature of the lenses and the refractive indices of the media which define the lenses.

5. A view forming module according to claim 2, wherein the periodic inter-element variation includes a variation in the positions, in the width direction of the display device, of the geometric axes of the lenticular lenses relative to their longitudinal centrelines.

6. A view forming module according to claim 5, wherein the average displacement, in the width direction of the display device, of the geometric axes of the lenticular lenses relative to their centrelines is substantially zero.

7. A view forming module according to claim 5, wherein the period of the inter-element variation corresponds to two lenticular lenses,
and wherein the positions, in the width direction of the display device, of the geometric axes of successive ones of the lenses are displaced in alternate directions relative to the longitudinal centrelines of the lenses.

8. A view forming module according to claim 5, wherein the period of the inter-element variation corresponds to three lenticular lenses, and wherein:
the position, in the width direction of the display device, of the geometric axis of a first lens in each triplet of the lenses is displaced a first direction relative to the longitudinal centreline of the lens,
the position, in the width direction of the display device, of the geometric axis of a second lens in each triplet of the lenses is undisplaced relative to the longitudinal centreline of the lens, and
the position, in the width direction of the display device, of the geometric axis of a third lens in each triplet of the lenses is displaced a second direction, opposite to the first direction, relative to the longitudinal centreline of the lens.

9. A view forming module according to claim 8, wherein the widths of all of the lenticular lenses are the same.

10. A view forming module according to claim 5, wherein the widths of the lenticular lenses vary, such that points on the surfaces of the lenticular lenses having positions, in the width direction of the display device, corresponding to the geometric axes of the lenses, define a plane.

11. A view forming module according to claim 1, configurable to function as a plurality of lens elements, wherein each lens element defines one of the view forming elements and comprises a plurality of sub-lenticular lenses,
wherein the geometric axes of the sub-lenticular lenses of each lens element have different positions in the width direction of the display device,
and wherein the periodic inter-element variation includes a variation in the relative positions, in the width direction of the display device, of the geometric axes of the sub-lenticular lenses relative to one another.

12. An autostereoscopic display device comprising:
an image forming means having a planar array of display pixels arranged in rows and columns for producing a display; and
a view forming module (101) according to claim 1, arranged over and in registration with the image forming means.

13. An autostereoscopic display device according to claim 12, wherein the average focal length of the lenticular lenses (103a, 103b) substantially corresponds to the distance between the planes of the image forming means and the view forming module.

14. An autostereoscopic imaging method comprising:
forming an image using a planar array of display pixels arranged in rows and columns; and
forming the image into a plurality of views projected towards a user in respective different directions using a plurality of view forming elements (103a, 103b) arranged across the array of display pixels, each view forming element directing the output from an adjacent group of the display pixels into the plurality of views,
wherein the geometry of the groups of display pixels defines a substantially periodic inter-group variation and/or the geometry of the view forming elements (103a, 103b) defines a substantially periodic inter-element variation in the width direction of the array of display pixels, for reducing brightness non-uniformities in the views.

15. A autostereoscopic display device comprising:
an image forming means having a planar array of display pixels arranged in rows and columns for producing a display,; and
a view forming module (101) arranged over and in registration with the image forming means, the view forming module being configurable to function as a plurality of view forming elements (103a, 103b) arranged in the width direction of the display device, each view forming element directing the output from an adjacent group of the display pixels into a plurality of views for projection towards a user in respective different directions,
wherein the geometry of the groups of display pixels defines a substantially periodic inter-group variation in the width direction of the display device, for reducing brightness non-uniformities in the views.
